(19) United States
(12) Patent Application Publication
(10) Pub. No.: US 2014/0204206 A1
(43) Pub. Date: Jul. 24, 2014

(54) LINE SCAN IMAGING FROM A RAW VIDEO SOURCE

(71) Applicant: CHRONOTRACK SYSTEMS CORP., Evansville, IN (US)

(72) Inventors: Paul Itoi, Davis, CA (US); Tate Knutstad, San Diego, CA (US)

(73) Assignee: CHRONOTRACK SYSTEMS CORP., Evansville, IN (US)

(21) Appl. No.: 13/745,973

(22) Filed: Jan. 21, 2013

(51) Int. Cl. H04N 7/18

(52) U.S. Cl. CPC H04N 7/18
USPC 348/143

(57) ABSTRACT

A line scan image is generated from a raw digital video source by receiving a digital video from a digital video camera configured to capture one or more moving objects of interest at a monitored location in the digital video, cropping the digital video or frames of the video around the monitored location, generating a plurality of cropped images from the cropped digital video, and assembling the plurality of cropped images in temporal order to generate the line scan image.

### TECHNICAL FIELD

The present disclosure relates generally to cameras and imaging. More particularly, the present disclosure relates to line scan imaging from a raw video source from a high frame rate video camera.

### BACKGROUND

In certain types of events, participants are timed to determine an order of finish of the participants in the event. For example, the participants in races may compete against each other in an event to try to achieve the fastest time among the participants. In some cases, prizes, awards, or other recognition may be attached to the order of finish, particularly for those participants who finish at or near the top of the order. Consequently, an accurate determination of the exact order of finish is an important consideration when organizing and managing such an event.

Some systems employ conventional photographic techniques to monitor the finish line of a race. For example, one or more high resolution cameras may be positioned with respect to the finish line (or other progress line) to capture sequential still images of the finish line at a high rate of speed. These images may be later manually reviewed by human judges, or automatically by a computer system designed to sequentially view the images. However, the former method of reviewing the images is tedious and requires a large commitment of time from one or more trained people, and the latter method involves the processing and organization of a large amount of data and information. In each instance, the time and/or cost outlay for the finish order review can be prohibitive for many types of events.

### SUMMARY

In one aspect, the present disclosure relates to a method for generating a line scan image including receiving a digital video from a digital video camera configured to capture one or more moving objects of interest at a monitored location in the digital video, cropping the digital video around the monitored location, generating a plurality of cropped images from the cropped digital video, and assembling the plurality of cropped images in temporal order to generate the line scan image.

In another aspect, the present disclosure relates to a system for generating a line scan image including one or more digital video cameras disposed relative to a monitored location configured to capture digital video of moving objects of interest that pass the monitored location, and a processor configured to crop the digital video around the monitored location, generate a plurality of cropped images from the cropped digital video, and assemble the plurality of cropped images in temporal order to generate the line scan image.

In a further aspect, the present disclosure relates to a method for generating a line scan image of a finish line in an athletic event, including receiving digital video from one or more digital video cameras configured to capture a plurality of participants in the athletic event as the plurality of participants cross the finish line, cropping each frame of the digital video around the finish line to generate a temporal series of cropped images, and assembling the plurality of cropped images in temporal order to generate the line scan image of the finish line, the line scan image of the finish line indicative of a finish order of the one or more participants in the athletic event.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a system including a digital video camera configured to capture video of participants in an event as the participants cross a monitored location.

FIG. 2 is a flow diagram of a process for converting raw video captured by the video camera into a line scan image according to the present disclosure.

FIGS. 3A-3D are diagrams illustrating steps in converting raw video captured by the video camera into a line scan image according to the present disclosure.

FIG. 4 is a flow diagram of an alternative process for converting raw video captured by the video camera into a line scan image according to the present disclosure.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

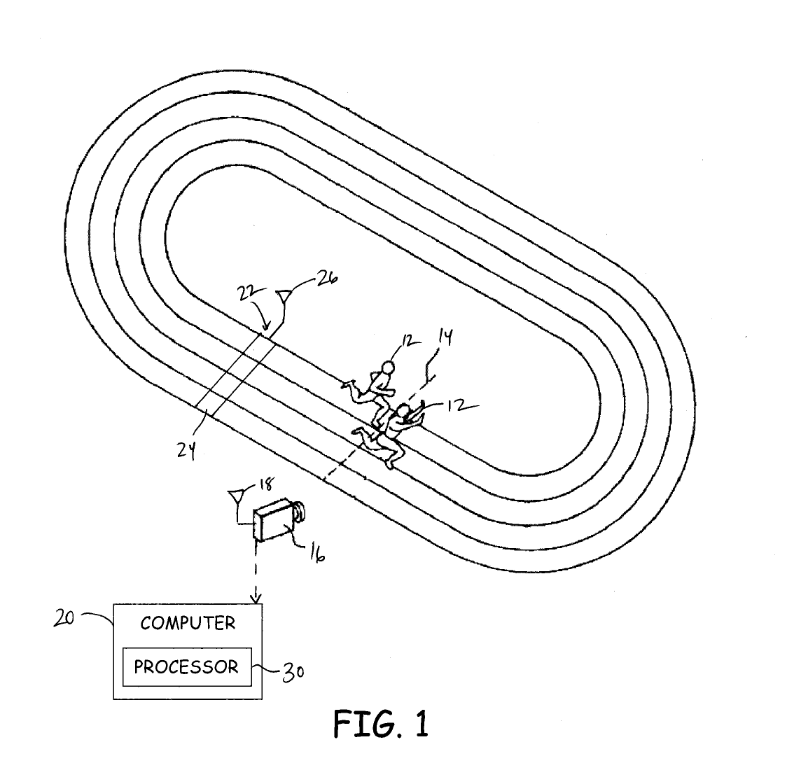

FIG. 1 illustrates a system 10 for capturing digital video of moving objects of interest 12 at a monitored location 14 and generating a line scan image from the digital video, according to an embodiment of the present disclosure. A digital video camera 16 is positioned with respect to the monitored location 14 to capture the moving objects of interest 12 as the moving objects of interest 12 pass the monitored location 14. While one monitored location 14 is shown, more than one monitored location 14 may be included in the system 10. In the illustrated embodiment, the monitored location 14 is a finish line in a running race, and the moving objects of interest 12 are participants in the running race. The system 10 may alternatively be configured to capture video of moving objects in other events or contexts, such as bicycle races, horse races, automobile races, and the like.

In some embodiments, the video camera 16 is positioned substantially perpendicular or orthogonal to a direction of motion of the moving objects of interest 12 at the monitored location 14. In some embodiments, the position and direction of the video camera 16 is stationary with respect to the monitored location 14. The video camera 16 is positioned a sufficient distance from the monitored location 14 to capture a full height of the objects of interest 12 as the objects of interest 12 pass the monitored location 14. In a running race, for example, the ability to capture the full height of the participants is useful because any portion of each participant (e.g., head, foot, arm, hand, etc.) may be the first body part to traverse the finish line. In some embodiments, the video camera 16 is stationary with respect to the monitored location 14.

The video camera 16 can include an internal memory configured to store the video captured at the monitored location. The video camera 16 can also include an antenna or other transmitting device 18 that is configured to transmit the captured video to a computer 20 for storage and/or processing of the captured video. The computer 20 can be located local to the video camera 16 at the site of the event being recorded, or may be located remotely from the event. For example, if the computer 20 is located locally to the video camera 16, the video camera 16 can transmit the captured video to the computer 20 via a wireless (e.g., Wi-Fi) or other local area connection. Alternatively, when the computer 20 is local to the video camera 16, the video camera 16 can be connected to the computer 20 via a high-speed wired connection (e.g., Category 5, IEEE 1394, USB, etc.). If the computer 20 is located remote from the video camera 16, the video camera 16 can transmit the captured video to the computer 20 via a connection to the internet or over a cellular network, for example.

The video camera 16 is configured to capture video at a predetermined frame rate (i.e., the frequency at which the video camera 16 produces unique consecutive images). The frame rate of the video camera 16 is sufficiently high to capture small differences in distance between the objects of interest 12 at the monitored location 14. The frame rate of the video camera 16 can be selected based on the measured or expected velocities of the objects of interest. In some embodiments, the frame rate of the video camera is at least about 100 frames per second (fps). In other embodiments, the video camera 16 has a frame rate of less than 100 fps. For example, in a running race, 100 fps can capture the motion of the objects of interest 12 at the monitored location 14 with sufficient resolution to determine positions in a “photo finish.” However, the video camera 16 used to capture motion of objects of interest 12 at higher velocities (e.g., horses, cars, etc.) may have higher frame rates.

The system 10 can be configured to enable the video camera 16 only when the objects of interest 12 are at or near the monitored location 14. In this way, bandwidth and storage space are conserved, since video is only captured during and around periods that include the objects of interest 14. In some embodiments, the video camera 16 is configured to be enabled upon receiving an enabling signal from another device or subsystem. For example, the system 10 can include a signal receiver 22 at a triggering location that receives signals from transponders (e.g., chips or radio frequency identification (RFID) tags) associated with each to the objects of interest 12. For example, in certain athletic events, each participant wears a chip or RFID tag that sends a signal to an overhead or underfoot receiver subsystem 24. An enabling signal can be transmitted via antenna 26 (or, alternatively, a wired connection) to the video camera 16 when a transponder associated with each object of interest 12 passes the signal receiver 22. The signal receiver 22 can be positioned a predetermined distance from the monitored location 14 such that the video camera 16 is active only for the period from when an object of interest 12 passes the signal receiver 22 (or a delay time thereafter) to a period of time (e.g., 1-3 seconds) after the object of interest 12 passes the monitored location 14.

The video camera 16 can alternatively be enabled using other means. For example, a camera or other imaging device employing range imaging may be positioned to generate an enabling signal when the objects of interest 12 pass a triggering location. This type of system may use point cloud modeling or other algorithms to determine when the objects of interest 12 pass the triggering location in three-dimensional space. Other potential devices that can generate an enabling signal for the video camera 16 upon a triggering event include, but are not limited to, a laser system that sends an enabling signal upon laser beam disruption by the objects of interest 12, or a motion detection system that sends an enabling signal upon detecting motion.

The computer 20 includes a processor 30 configured to process the raw digital video and generate a line scan image, as will be described in more detail below. In some embodiments, the computer 20 that receives the video from the video camera 16 also processes the video to generate the line scan image, as is shown. Alternatively, one computer may receive and store the video from the video camera 16 while a separate computer may be employed to process the video.

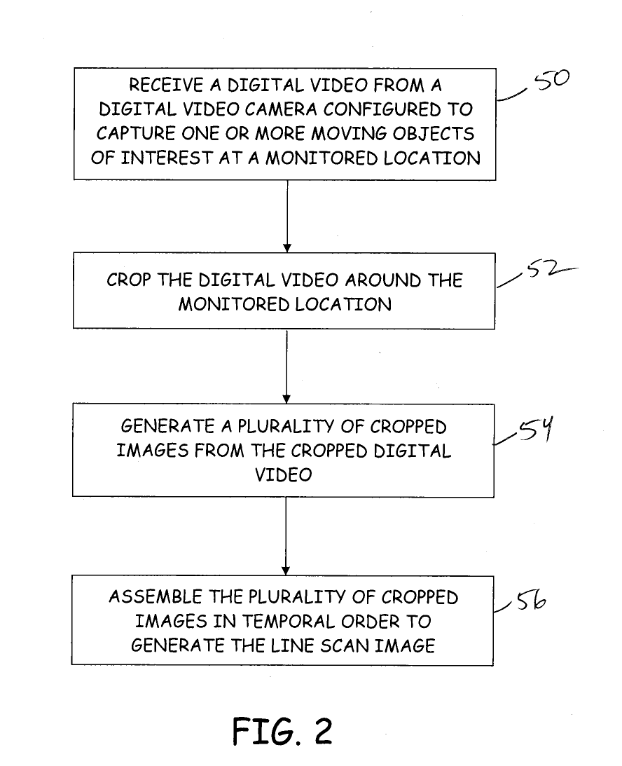

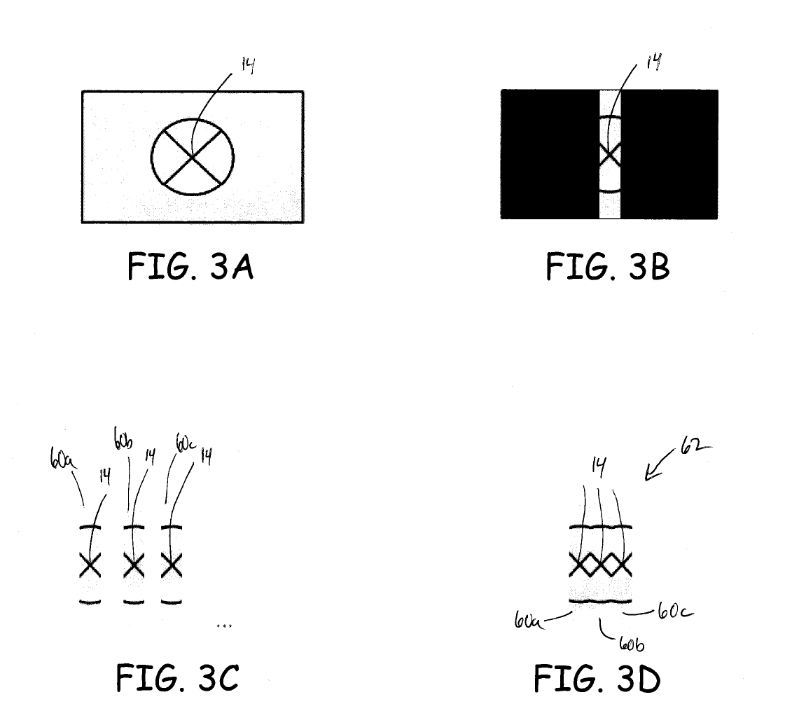

FIG. 2 is a flow diagram of a process for converting raw video captured by the video camera 16 into a line scan image according to the present disclosure, and FIGS. 3A-3D are diagrams illustrating the steps described in FIG. 2. In step 50, the raw video is received from the video camera 16 by the computer 20. FIG. 3A is a screen shot of the video from the video camera including the monitored location 14 (e.g., a finish line). The raw video can be chunked or otherwise manipulated to reduce the bandwidth burden of transmitting the video to the computer 20. Programming tools, such as openCV, can be used to process the stream of video data from the video camera 16 in substantial real-time. The raw video may be preprocessed by the processor 30 when received by the computer 20 to reduce the amount of storage space needed to store the video and the processing resources used to generate the line scan image.

The processor 30 can then decode the raw video from its compressed format (e.g., .mov, .flv, .mp4, etc.) into an uncompressed format. The processor 30 can then process the decoded video to remove the audio portion of the video. If necessary, the processor 30 can also de-interlace the decoded video file.

In step 52, the processor 30 crops the decoded video file around the monitored location. FIG. 3B illustrates the screen shot of FIG. 3A cropped around the monitored location 14. The processor 30 crops the video such that the cropped portion extends perpendicular to the direction of motion of the objects of interest 12. For example, for a race, the processor 30 can crop the video at and around the finish line. In some embodiments, the processor 30 crops the video to a width of one to five pixels around the monitored location 14. For example, in a 640 pixel length and a 480 pixel width video, with the monitored location extending along the width of the video, the processor 30 may crop the video to a 1-5 pixel length and a 480 pixel width. The cropped video may then be re-encoded into the format of the file prior to the decoding described above. The removal of the audio from and cropping of the video reduces the amount of information processed by the processor 30 in subsequent steps.

In step 54, the processor 30 generates a plurality of cropped images from the cropped video generated in step 52. FIG. 3C illustrates a series of cropped images 60a, 60b, 60c, . . . that capture the monitored location 14 at different moments in time. The processor 30 can generate the series of cropped images as a function of the frame rate of the video (e.g., a 100 fps video generates 100 cropped images per second of video), or at a “virtualized” frame rate that is less than the frame rate of the video. In the latter case, for example, using every other frame in a 100 fps video generates 50 cropped images per second of video.

The processor 30 can then process the series of cropped images 60a, 60b, 60c, . . . to identify areas of motion in the cropped images. One approach to identifying areas of motion in the images 60a, 60b, 60c, . . . includes the processor 30 identifying a characteristic histogram of the RGB distribution in the images. As another example, the processor 30 can match pixels of the images 60a, 60b, 60c, . . . to pixels of images that are known to include or not include areas of motion. In some embodiments, the processor 30 is programmed with tools from a programming library (e.g., openCV) to perform the comparison of images 60a, 60b, 60c, . . . to images with known pixel distribution. The images 60a, 60b, 60c, . . . that do not include motion can then be discarded to further reduce the computational and storage load of the line scan image generation. This step of discarding images that do not include motion can be particularly useful in systems that do not include the camera control mechanisms described above to reduce the processing burden for generating the line scan image.

In step 56, the processor 30 can then assemble the plurality of cropped images in temporal order to generate the line scan image. FIG. 3D illustrates a portion of a line scan image 62 including an assembly of images 60a, 60b, 60c. A typical line scan image 62 can include a large number of cropped images 60 arranged in temporal order. For example, a line scan image including a one minute period generated from a 100 fps video includes up to 6,000 cropped images 60. The processor 30 can assemble the images 60 in temporal order based on a timestamp or other time identifier associated with each of the images. Alternatively, each image can be assigned a numeric value to demarcate its place in the final image.

When completed, the composite line scan image 62 can be used to determine the order or time at which each of the objects of interest 12 passes the monitored location 14. For example, in a running race, the line scan image 62 can be used to determine the order of finish of the participants, as well as the finishing time of the participants. This can be accomplished by using the pixels of the line scan image 62 as a representative of time. The timing is a function of the number of pixels in each cropped image, as described above in step 52, and the frame rate of the video. For example, if the cropped video has a length of four pixels, and the video has a frame rate of 100 fps, each 400 pixels along the line scan image 62 represents one second of time. The processor 30 can also incorporate a timeline into the line scan image 62 to allow a viewer of the line scan image to quickly discern the time at which each object of interest 12 crosses or passes the monitored location 14.

If the objects of interest 12 are associated with a transponder or other device that communicates identification information to the computer 20 as the objects of interest 12 pass the monitored location (e.g., RFID tag crossing a finish line in a race), each object of interest 12 can be identified in the line scan image 62 by correlating the identification information with the finish time of the object of interest 12. The timing information for each object of interest 12 can then be saved in a user account associated with the object of interest 12. The timing information can also be linked to a scoring engine to provide scoring data for each object of interest 12 based on the timing information.

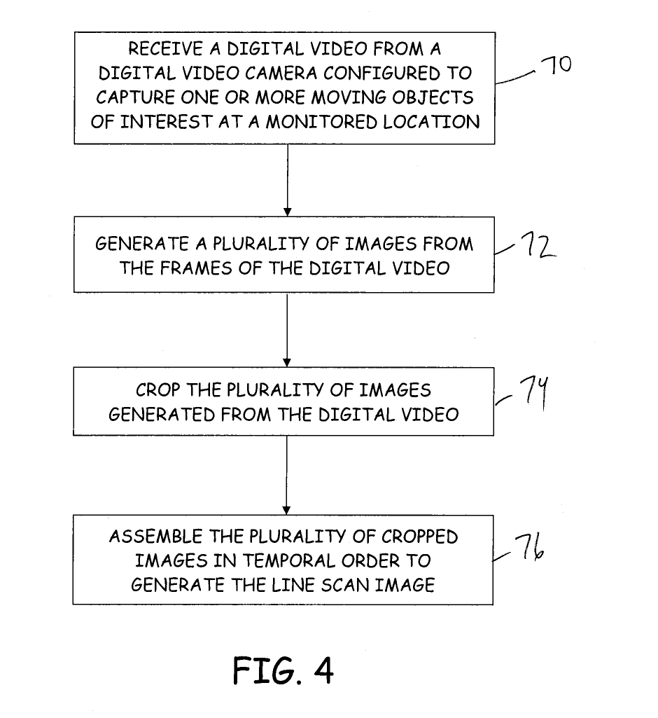

FIG. 4 is a flow diagram of an alternative process to generating a line scan image from a raw video source, according to the present disclosure. In step 70, digital video is received by the computer 20 from a digital video camera 16 in substantially the same manner as described above with regard to step 50 in FIG. 2. In step 72, the processor 30 generates a plurality of images from the frames of the digital video. The number of images generated is a function of the frame rate of the video. Thus, for a 100 fps video, 100 images are generated for each second of video. The frame rate of the video can also be “virtualized,” as described above. In this embodiment, the images generated from the video have the same pixel resolution as the raw video. That is, the video is not cropped before generating the plurality of images.

In step 74, the processor 30 crops the images generated from the video around the monitored location 14. The processor 30 crops the images such that the cropped portion in each image extends perpendicular to the direction of motion of the objects of interest 12. For example, for a race, the processor 30 can crop the images at and around the finish line. In some embodiments, the processor 30 crops the image to a width of one to five pixels around the monitored location 14. For example, in 640 pixel length and a 480 pixel width images, with the monitored location extending along the width of the images, the processor 30 may crop the images to a 1-5 pixel length and a 480 pixel width. Then, in step 76, the processor assembles the series of cropped images in temporal order in substantially the same manner as described above with regard to step 76 in FIG. 2.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

We claim:

1. A method for generating a line scan image, the method comprising:
receiving a digital video from a digital video camera configured to capture one or more moving objects of interest at a monitored location in the digital video;
cropping the digital video around the monitored location;
generating a plurality of cropped images from the cropped digital video; and
assembling the plurality of cropped images in temporal order to generate the line scan image.

2. The method of claim 1, wherein receiving the digital video comprises:
receiving the digital video from a stationary digital video camera positioned to capture the digital video in a direction substantially orthogonal with respect to a motion direction of the one or more moving objects of interest at the monitored location.

3. The method of claim 1, wherein, prior to the receiving step, the method further comprises:
enabling the digital video camera when an enabling signal is received, the enabling signal generated upon a triggering event from the one or more moving objects of interest.

4. The method of claim 3, wherein the enabling signal is generated when the one or more moving objects of interest pass a triggering location a predetermined distance from the monitored location.

5. The method of claim 1, wherein the cropping step comprises cropping the digital video in a direction substantially orthogonal to a motion direction of the moving objects of interest.

6. The method of claim 1, wherein the digital video comprises a frame rate, and wherein the frame rate is selected based on a velocity of the one or more moving objects of interest.

7. The method of claim 6, wherein the frame rate is at least 100 frames per second.

8. A system for generating a line scan image, the system comprising:
one or more digital video cameras disposed relative to a monitored location configured to capture digital video of moving objects of interest that pass the monitored location;
a processor configured to crop the digital video around the monitored location, generate a plurality of cropped images from the cropped digital video, and assemble the plurality of cropped images in temporal order to generate the line scan image.

9. The system of claim 8, wherein the one or more digital video cameras comprise at least one stationary camera positioned to capture the digital video in a direction substantially orthogonal with respect to a motion direction of the moving objects of interest at the monitored location.

10. The system of claim 8, and further comprising:
one or more triggering sensors configured to enable at least one of the one or more digital video cameras upon a triggering event from the one or more moving objects of interest.

11. The system of claim 10, wherein the one or more triggering sensors are positioned a predetermined distance from the monitored location, and wherein the one or more triggering sensors are configured to enable the at least one of the one or more digital video cameras when the moving objects of interest pass the one or more triggering sensors.

12. The system of claim 11, wherein the moving objects of interest are each associated with a transponder that communicates with the one or more triggering sensors as the associated moving object of interest passes the one or more triggering sensors.

13. The system of claim 8, wherein the processor is configured to crop the digital video in a direction substantially orthogonal to a motion direction of the moving objects of interest.

14. The system of claim 8, wherein the digital video comprises a frame rate, and wherein the frame rate is selected based on a velocity of the one or more moving objects of interest.

15. The system of claim 14, wherein the frame rate is at least 100 frames per second.

16. A method for generating a line scan image of a finish line in an athletic event, the method comprising:
receiving digital video from one or more digital video cameras configured to capture a plurality of participants in the athletic event as the plurality of participants cross the finish line;
cropping each frame of the digital video around the finish line to generate a temporal series of cropped images; and
assembling the plurality of cropped images in temporal order to generate the line scan image of the finish line, the line scan image of the finish line indicative of a finish order of the one or more participants in the athletic event.

17. The method of claim 16, wherein receiving the digital video comprises:
receiving the digital video from a stationary digital video camera positioned to capture the digital video in a direction substantially orthogonal with respect to a motion direction of the plurality of participants.

18. The method of claim 16, wherein, prior to the receiving step, the method further comprises:
enabling the digital video camera when an enabling signal is received, the enabling signal generated upon a triggering event initiated by at least one of the plurality of participants.

19. The method of claim 18, wherein the enabling signal is generated when the at least one of the plurality of participants pass a triggering location a predetermined distance from the finish line.

20. The method of claim 19, and further comprising:
receiving the enabling signal from a transponder associated one of the plurality of participants as the transponder passes the triggering location.
